(19) United States
(12) Patent Application Publication
(10) Pub. No.: US 2003/0073417 A1
(43) Pub. Date: Apr. 17, 2003

(54) Transmitter circuit, article of manufacture, and method of transmitting

(75) Inventors: John S. Nantz, Brighton, MI (US); Riad Ghabra, Dearborn Hts., MI (US); Qingfeng Tang, Novi, MI (US); Keith A. Walker, Redford, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: Lear Corporation, Southfield, MI

(21) Appl. No.: 09/975,684

(22) Filed: Oct. 11, 2001

(51) Int. Cl. H04B 1/04

(52) U.S. Cl. 455/118; 455/255

(57) ABSTRACT

A transmitter circuit includes an oscillator circuit and an amplifier circuit. The oscillator circuit includes a surface acoustic wave (SAW) resonator and generates a carrier signal. The amplifier circuit receives the carrier signal and a data signal, and generates an output signal as the carrier signal modulated with the data signal.

### BACKGROUND OF THE INVENTION

1. Field of the Invention

The present invention relates to a transmitter circuit, article of manufacture, and method of transmitting utilizing a surface acoustic wave (SAW) resonator as a frequency control element in an oscillator.

2. Background Art

A surface acoustic wave (SAW) includes coupled compressional and shear waves. The SAW energy is near the surface. SAW resonators may be used as frequency control elements in oscillators. SAW stabilized oscillators have been used in the past to form SAW stabilized transmitters.

In an existing SAW stabilized transmitter, a data signal is used to turn the SAW stabilized oscillator on and off to create a sequence of radio frequency bursts. The sequence of radio frequency bursts passes through an amplifier and is transmitted with an antenna. The SAW stabilized oscillator of the SAW stabilized transmitter takes a certain amount of time to turn on. As such, the maximum data rate for the data signal is dependent on the amount of time that it takes to turn on the SAW stabilized oscillator because the oscillator is turned on and off to create the sequence of radio frequency bursts.

Some existing patents relating to signals and systems include U.S. Pat. Nos. 2,312,810; 3,648,186; 3,706,038; 4,661,819; 4,684,853; 5,146,613; 5,793,261; and 5,920,234. U.S. Pat. No. 2,312,810 describes a signal generator for producing an audio frequency wave that is interrupted or chopped up into characters. U.S. Pat. No. 3,648,186 describes a signal amplification unit in which a pulse width modulated signal is employed to key a radio frequency carrier wave. U.S. Pat. No. 3,706,038 describes a pulse transmitter including means for controlling the amplitude and phase of output pulses. U.S. Pat. No. 4,661,819 describes a doppler tolerant binary phase coded pulse compression system. U.S. Pat. No. 4,684,853 describes a garage door opener using a transmitter with a SAW resonator. U.S. Pat. No. 5,146,613 describes a low power ultra high frequency data transceiver. U.S. Pat. No. 5,793,261 describes a SAW stabilized frequency shift keying oscillator circuit. U.S. Pat. No. 5,920,234 describes a buffered oscillator transmitter arrangement for power specific applications having parasitic impedances.

For the foregoing reasons, there is a need for an improved transmitter circuit that allows for greater data rates in a SAW stabilized transmitter.

### SUMMARY OF THE INVENTION

It is, therefore, an object of the present invention to provide a transmitter circuit including a SAW stabilized oscillator circuit and an amplifier circuit wherein the amplifier circuit modulates a carrier signal produced by the SAW oscillator with a data signal.

In carrying out the above object, a transmitter circuit is provided. The transmitter circuit comprises an oscillator circuit and an amplifier circuit. The oscillator circuit includes a surface acoustic wave (SAW) resonator. The oscillator circuit generates a carrier signal. The amplifier circuit receives the carrier signal and receives a data signal. The amplifier circuit generates an output signal as the carrier signal modulated with the data signal.

In a suitable implementation, the transmitter circuit further comprises an antenna and control logic. The antenna is coupled to the amplifier circuit to transmit the output signal. The control logic is configured to generate the data signal. The control logic may be, for example, a microprocessor. Preferably, the transmitter circuit further includes an assertable switch connected to the control logic. The control logic is configured such that assertion of the switch causes the control logic to generate the data signal. In a suitable implementation, the oscillator circuit further comprises a bipolar junction transistor, and the amplifier circuit further comprises a bipolar junction transistor. Alternatively, devices such as field effect transistors, or any other active devices that can provide gain at the desired frequency may be used. Preferably, the carrier signal has a frequency of at least 300 MHz.

Further, in carrying out the present invention, an article of manufacture is provided. The article of manufacture comprises a housing, at least one circuit board, an oscillator circuit, and an amplifier circuit. The oscillator circuit is on the at least one circuit board. The oscillator circuit includes a surface acoustic wave (SAW) resonator. The oscillator circuit generates a carrier signal. The amplifier circuit in on the at least one circuit board. The amplifier circuit receives the carrier signal and receives a data signal. The amplifier circuit generates an output signal as the carrier signal modulated with the data signal.

Still further, in carrying out the present invention, a method of transmitting is provided. The method comprises generating a carrier signal with an oscillator circuit including a surface acoustic wave (SAW) resonator. The method further comprises generating a data signal, generating an output signal, and transmitting the output signal. The output signal is generated with an amplifier circuit receiving the carrier signal and receiving the data signal. The amplifier circuit generates the output signal as the carrier signal modulated with the data signal.

The advantages associated with embodiments of the present invention are numerous. For example, embodiments of the present invention extend the maximum data rate for SAW stabilized transmitters by utilizing an amplifier circuit to generate an output signal as the carrier signal modulated with the data signal. Advantageously, the SAW stabilized oscillator continuously produces the carrier signal, while the data signal modulates the carrier signal at the amplifier circuit.

The above object and other objects, features and advantages of the present invention are readily apparent from the following detailed description of the preferred embodiment when taken in connection with the accompanying drawings.

### BRIEF DESCRIPTION OF THE DRAWINGS

FIG. 1 is a schematic diagram illustrating an embodiment of the present invention;

FIG. 2 is a circuit diagram illustrating an embodiment of the present invention;

FIG. 3 illustrates an article of manufacture made in accordance with the present invention; and

FIG. 4 is a flow chart illustrating a method of the present invention.

### DETAILED DESCRIPTION OF THE PREFERRED EMBODIMENTS

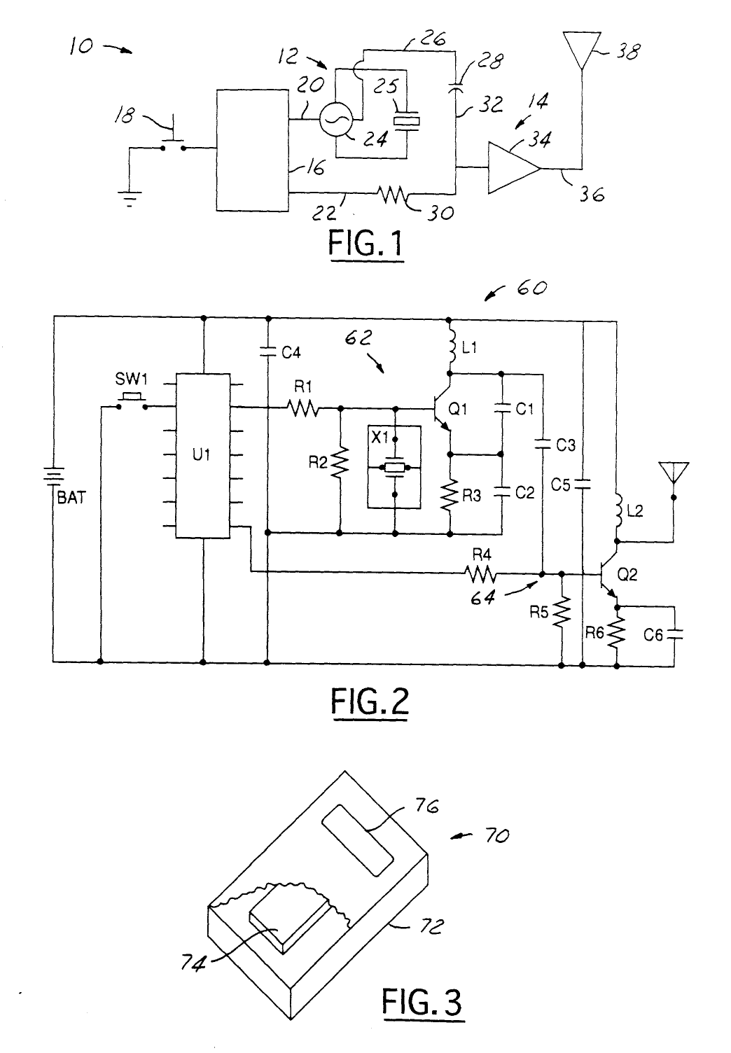

In FIG. 1, a transmitter circuit of the present invention is generally indicated at 10. Transmitter circuit 10 includes an oscillator circuit 12 and an amplifier circuit 14. Control logic 16 is operative to turn the oscillator on and off and is operative to generate a data signal in response to assertion of pushbutton switch 18. More specifically, control logic 16 may be implemented as a microprocessor or microcontroller, and produces a signal at 20 to turn on oscillator circuit 12 and also produces a data signal at 22. Oscillator circuit 12 includes oscillation source 24 and stabilizing SAW resonator 25. Oscillator circuit 12 produces a carrier signal at 26. The carrier signal at 26 is received by amplifier circuit 14, through coupling capacitor 28, at input 32. Amplifier circuit 14, in addition to receiving the carrier signal, also receives a data signal through input resistor 30. In turn, the carrier signal is modulated with the data signal, and amplifier 34 of amplifier circuit 14 produces an output signal at 36 as the carrier signal modulated with the data signal. The output signal is transmitted by antenna 38 which is coupled to amplifier circuit 14.

It is appreciated that embodiments of the present invention utilize an oscillator circuit to produce an unmodulated carrier signal and then modulate the carrier signal with the data signal at the amplifier circuit. By allowing the oscillator circuit to run continuously, instead of switching the oscillator circuit off and on, the maximum data rate is increased. For example, in a prior art SAW stabilized transmitter having a maximum data rate of 2.5 kHz, providing the improvement contemplated by the present invention (that is, modulating the carrier signal with the data signal at the amplifier circuit) extends the maximum data rate to better than 1 MHz. Of course, the improvement to the maximum data rate may vary depending on the application as appreciated by one of ordinary skill in the art. In addition, embodiments of the present invention have improved battery life of the transmitter because the data is transmitted much faster, and therefore the average on time of the unit is much lower. Further, the increased maximum data rate allows for higher radiated peak power because duty factor may be kept lower. And further, embodiments of the present invention decrease latency time between transmitter operation and receiver response, therefore allowing for more feature content in the transmitted data.

In a suitable implementation of the transmitter circuit shown in FIG. 1, when pushbutton 18 is depressed, output 20 goes from a low state to a high state and remains high throughout the period of data transmission. After the output 20 has been at a high state for a period of 25 microseconds (in this example), then data output 22 outputs data to amplifier circuit 14, turning the amplifier 34 on and off at the data rate. It is appreciated that any SAW stabilized oscillator configuration may be used and any type and/or number of amplifiers may be used.

The SAW stabilized oscillator requires a certain amount of time to turn on (25 microseconds in this example), therefore limiting the data rate which can be transmitted directly through the oscillator. In accordance with the present invention, the addition of the amplifier allows the oscillator to run continuously and the amplifier can shift the output power of the oscillator at a maximum data rate limited by the switching speed of the amplifier.

FIG. 2 illustrates a suitable circuit level implementation for the transmitter circuit of FIG. 1, with the circuit being generally indicated at 60. Transmitter circuit 60 includes battery power source (BAT) but may optionally include any other suitable power source. Switch SW1 is connected to an input pin of integrated circuit chip U1. Capacitors C4 and C5 stabilize the supply voltage to the rest of transmitter circuit 60. An oscillator circuit 62 includes resistors R1, R2, and R3, and capacitors C1 and C2, as well as transistor Q1, inductor L1, and SAW resonator X1. In the presence of a signal from integrated circuit chip U1 sufficient to turn on transistor Q1, oscillator circuit 62 provides an oscillating output. Amplifier circuit 64 includes resistors R4, R5, and R6, as well as capacitor C6, transistor Q2, and inductor L2. The data signal is presented by integrated circuit chip U1 in response to the assertion of switch SW1. Prior to providing the data signal, integrated circuit chip U1 turns on transistor Q1. The carrier signal from oscillator circuit 62 is coupled with capacitor C3 such that the carrier signal is modulated with the data signal at the input of amplifier circuit 64. Preferably, on/off keying is performed, but other modulation techniques may also be used. The antenna coupled to amplifier circuit 64 transmits the output signal of amplifier circuit 64. Further, the carrier signal preferably has a frequency above 300 MHz.

FIG. 3 illustrates an article of manufacture made in accordance with the present invention at 70. Article 70 is a transmitter suitable for many applications and includes a housing 72 and at least one circuit board 74. The circuit board 74 includes a transmitter circuit of the present invention such as the exemplary transmitter circuit of FIG. 2. Pushbutton 76 causes the transmitter to modulate the carrier signal with the data signal and transmit the output signal. Embodiments of the present invention are suitable for many applications such as, for example, garage door openers, keyless entry, and tire pressure monitoring. That is, the article of manufacture may take any of a number of forms. In addition, other aspects of the transmitter configuration may vary depending on the application. For example, the battery may be replaced with a different power source and the switch may be replaced with a different element.

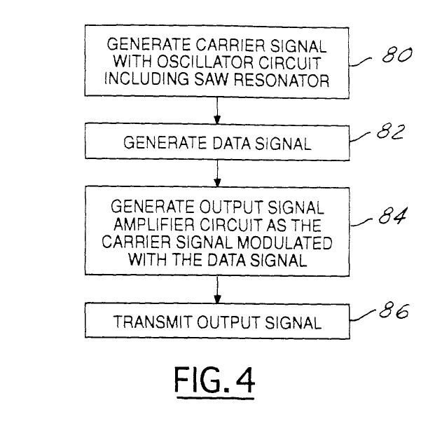

A method of the present invention is shown in FIG. 4. At block 80, a carrier signal is generated with an oscillator circuit. The oscillator circuit includes a SAW resonator. At block 82, a data signal is generated. At block 84, an output signal is generated with an amplifier circuit. The amplifier circuit receives the carrier signal and receives the data signal. The amplifier circuit generates an output signal as the carrier signal modulated with the data signal. At block 86, the output signal is transmitted.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A transmitter circuit comprising:
an oscillator circuit including a surface acoustic wave (SAW) resonator, the oscillator circuit generating a carrier signal; and
an amplifier circuit receiving the carrier signal and receiving a data signal, the amplifier circuit generating an output signal as the carrier signal modulated with the data signal.

2. The transmitter circuit of claim 1 further comprising:
an antenna coupled to the amplifier circuit to transmit the output signal.

3. The transmitter circuit of claim 1 further comprising:
control logic configured to generate the data signal.

4. The transmitter circuit of claim 3 wherein the control logic comprises:
a microprocessor.

5. The transmitter circuit of claim 3 further comprising:
an assertable switch connected to the control logic, wherein the control logic is configured such that assertion of the switch causes the control logic to generate the data signal.

6. The transmitter circuit of claim 1 wherein the oscillator circuit further comprises:
a bipolar junction transistor.

7. The transmitter circuit of claim 1 wherein the amplifier circuit further comprises;
a bipolar junction transistor.

8. The transmitter circuit of claim 1 wherein the carrier signal has a frequency of at least 300 MHz.

9. An article of manufacture comprising:
a housing;
at least one circuit board;
an oscillator circuit on the at least one circuit board, the oscillator circuit including a surface acoustic wave (SAW) resonator, the oscillator circuit generating a carrier signal; and
an amplifier circuit on the at least one circuit board, the amplifier circuit receiving the carrier signal and receiving a data signal, the amplifier circuit generating an output signal as the carrier signal modulated with the data signal.

10. The article of claim 9 further comprising:
an antenna coupled to the amplifier circuit to transmit the output signal.

11. The article of claim 9 further comprising:
control logic configured to generate the data signal.

12. The article of claim 11 wherein the control logic comprises:
a microprocessor.

13. The article of claim 11 further comprising:
an assertable switch connected to the control logic, wherein the control logic is configured such that assertion of the switch causes the control logic to generate the data signal.

14. The article of claim 9 wherein the oscillator circuit further comprises:
a bipolar junction transistor.

15. The article of claim 9 wherein the amplifier circuit further comprises;
a bipolar junction transistor.

16. The article of claim 9 wherein the carrier signal has a frequency of at least 300 MHz.

17. A method of transmitting comprising:
generating a carrier signal with an oscillator circuit including a surface acoustic wave (SAW) resonator;
generating a data signal;
generating an output signal with an amplifier circuit receiving the carrier signal and receiving the data signal, the amplifier circuit generating an output signal as the carrier signal modulated with the data signal; and
transmitting the output signal.
